(19) United States
(12) Patent Application Publication
(10) Pub. No.: US 2015/0181799 A1
(43) Pub. Date: Jul. 2, 2015

(54) GROUND OPENER ASSEMBLY WITH DUAL GAUGE CONTROL

(71) Applicant: ONE PASS IMPLEMENTS INC., Langbank (CA)

(72) Inventors: Patrick M. Beaujot, Langbank (CA); Barry K. Melanson, Kennedy (CA)

(21) Appl. No.: 14/413,397

(22) PCT Filed: Jul. 25, 2013
(86) PCT No.: PCT/CA2013/050581

§ 371 Date: Jan. 7, 2015

Related U.S. Application Data
(60) Provisional application No. 61/676,133, filed on Jul. 26, 2012.

(51) Int. Cl. A01C 7/06; A01C 5/06; A01B 49/06

(52) U.S. Cl. CPC A01C 7/06; A01B 49/06; A01C 5/062; A01C 5/068

(57) ABSTRACT

A ground opener assembly mountable to a tool bar of a seeder for depositing a at least one product into the ground is provided, comprising: a first member having a proximal end and a distal end, the proximal end of the first member pivotably attached to the tool bar; a second member having a proximal end and a distal end, said proximal end being pivotably attached to the distal end of the first member; a first arm having one end attached at or near the proximal end of the second member and a second arm having one end attached at or near the distal end of the second member, whereby the second member, first arm and second arm operate as a single unit; a first opener attached at or near the proximal end of the second member for forming a furrow into the ground and depositing a first product therein; a second opener attached at or near the distal end of the second member for forming a furrow into the ground and depositing a second product therein; a front gauging device attached to the free end of the first arm and a back gauging device attached to the free end of the second arm; and a biasing device operative to exert a downward bias force on the second member, the first and second openers, and the front and back gauging devices,

The present invention relates to a ground opener assembly for a seeding or planting unit and more particularly to a dual opener ground opener assembly having a front and back gauge assembly for depth control to maintain the depth of the openers so that material/product placement, such as seeds and/or other supplement products including, but is not limited to, fertilizer, inoculants, herbicide, etc., is constant.

### BACKGROUND OF THE INVENTION

It is desirable when seeding/planting a field that particulate materials, such as seed, fertilizer, inoculants and other seed treatments, are applied to the field at a constant depth to ensure uniform plant emergence. There exists a variety of ground opener assemblies, both single opener assemblies and dual opener assemblies, which are designed to attempt to control the depth of the furrows as constant as possible.

The requirement for accurate product placement is even more critical when a farmer is placing two agricultural products such as seed and fertilizer into the ground in a single pass of the seeding device, as is often the case when seeding under no-till or zero till conditions. There exists a number of trailing arm ground opener assemblies that that attempt to control furrow depth. One such trailing arm ground opener assembly comprises a single long arm that is attached to the frame of the seeding or planting unit by a single pivot (see, for example, U.S. Pat. No. 5,396,851). Attached to the single long arm are two ground engaging openers, for example, a fertilizer knife and a seed knife, and the depths of both of the openers are controlled by a packer gauge wheel attached onto the end of the arm. However, in uneven terrain, the distance between the frame and the ground varies, resulting in the trailing arm moving up and down about its pivotal attachment to the frame such that the distance from the attachment of the two furrow openers to the ground varies. Thus, the depths of the furrows may vary, as may the placement of the particulate material.

Thus, by placing all of the fertilizer and seed in one operation, it becomes important to separate the seed and fertilizer consistently in order to prevent seed burn from the fertilizer. Research has shown that it is advantageous to place fertilizer below and to the side of the seed. In zero till conditions of the Northern Great Plains of North America, research also has shown that using a narrow knife opener to aerate and warm up the cold wet soils after the snow melt is important to speed up germination. The knives have to be very accurately gauged in order to insure the proper depth of each material. For example, if the seed is placed too deep, in cold wet conditions this would slow crop emergence and if placed too shallow, it may leave the seed in the dry surface soil.

An additional challenge that is faced by farmers when using two knife openers is that the high residue crops leave a lot of straw standing or on the ground and the knives tend to bunch the straw into piles causing germination problems or, at times, plugging the seeder altogether. Using a disc opener may solve this problem to some extent; however, disc openers do not warm the soil and often do not cut through the straw. As a result, often the seed is placed on top of uncut straw, which is unacceptable for many reasons. Another evolution is that with improved breeding and genetically modified varieties corn crops being grown further north and west each year, the corn stocks are bigger and stronger. This means many farmers are growing corn with a planter and then plant small grains like canola or wheat with an air drill. The challenge when using knife opener air drills in corn stubble is even greater so as to be able to plant through the straw.

There is a need for a ground opener assembly, in particular, an assembly having two openers such as dual knives, dual discs, and the like, which addresses some of the problems encountered with the prior art assemblies. In particular, there is a need for an assembly that provides good depth control and soil firming that can also be adapted to have an aggressive means for cutting and clearing residue from in front of the knives, discs, and the like.

### SUMMARY OF THE INVENTION

In a first aspect, a ground opener assembly mountable to a tool bar of a seeder for depositing at least one product into the ground is provided, comprising:
a first member having a proximal end and a distal end, the proximal end of the first member pivotably attached to the tool bar;
a second member having a proximal end and a distal end, said proximal end being pivotably attached to the distal end of the first member;
a first arm having one end attached at or near the proximal end of the second member and a second arm having one end attached at or near the distal end of the second member, whereby the second member, first arm and second arm operate as a single unit;
a first opener attached at or near the proximal end of the second member for forming a furrow into the ground and depositing a first product therein;
a second opener attached at or near the distal end of the second member for forming a furrow into the ground and depositing a second product therein;
a front gauging device attached to the free end of the first arm and a back gauging device attached to the free end of the second arm; and
a biasing device operative to exert a downward bias force on the second member, the first and second openers, and the front and back gauging devices.

The addition of a pivot point between the first member and the second member allows downward forces to be applied by the biasing device (e.g., hydraulic cylinder) and that force will be supplied to both the front gauging device, which device can also act as a disc/residue clearing gauging device, and to the rear packer/gauging device. This ability to distribute forces to the front and rear gauging device allows the opener assembly, and, hence, the two openers, to follow the terrain more consistently. It is also unique to have the rear packer/gauge wheel act as the main seed depth control allowing the front opener to lift without losing seed depth.

In one embodiment, the first opener comprises a first knife and the second opener comprises a second knife.

In one embodiment, the ground opener assembly further comprises a stopping device for controlling the depth of the openers of the ground opener assembly during extreme situations such as transport lift, very deep holes, or when going uphill or downhill, thereby acting to limit the movement of the ground opener assembly. In one embodiment, the stopping device comprises a stopper arm having a front end pivotally attached to the tool bar and a rear end pivotally attached to the second member by means of a slotted guide.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a schematic side view of one embodiment of a ground opener assembly of the present invention in operation on flat ground.

FIG. 2 is a schematic side view of the ground opener assembly of FIG. 1 showing the tripping mechanism of the first dispensing implement.

FIG. 3 is a schematic side view of the ground opener assembly of FIG. 1 in operation on elevated ground.

FIG. 4 is a schematic side view of the ground opener assembly of FIG. 1 in operation in a gully.

FIG. 5 is a schematic side view of the ground opener assembly of FIG. 1 in operation on a 20 degree downward slope.

FIG. 6 is a schematic side view of the ground opener assembly of FIG. 1 in operation on a 20 degree upward slope.

FIG. 7 is a schematic side view of the ground opener assembly of FIG. 1 in the transport position.

FIG. 8 is a perspective view of an embodiment of a ground opener assembly of the present invention which is designed to accept a variety of implements.

FIG. 9 shows a perspective view of an embodiment of a ground opener assembly of the present invention with an aggressive row cleaner/gauge element commonly used in corn stubble.

FIG. 10 is a schematic side view of another embodiment of a ground opener assembly of the present invention in operation on flat ground.

FIG. 11a is a schematic side view of the ground opener assembly of FIG. 10 in operation on a 20 degree downward slope.

FIG. 11b is an enlargement of the slotted guide of FIG. 11a.

FIG. 12a is a schematic side view of the ground opener assembly of FIG. 10 in operation on a 20 degree upward slope.

FIG. 12b is an enlargement of the slotted guide of FIG. 12a.

FIG. 13a is a schematic side view of the ground opener assembly of FIG. 10 in the transport position.

FIG. 13b is an enlargement of the slotted guide of FIG. 13a.

FIG. 13c is a schematic view of the ground opener assembly of FIG. 10 where the stopper arm of the present invention has been removed.

FIG. 14a is a schematic view of a ground opener assembly having a stopper arm of the present invention.

FIG. 14b is a rear perspective view of the front gauging device of the ground opener assembly of FIG. 14a.

FIG. 15a is a schematic view of the ground opener assembly of FIG. 14a where the stopper arm of the present invention has been removed.

FIG. 15b is a rear perspective view of the front gauging device of the ground opening assembly of FIG. 15a.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

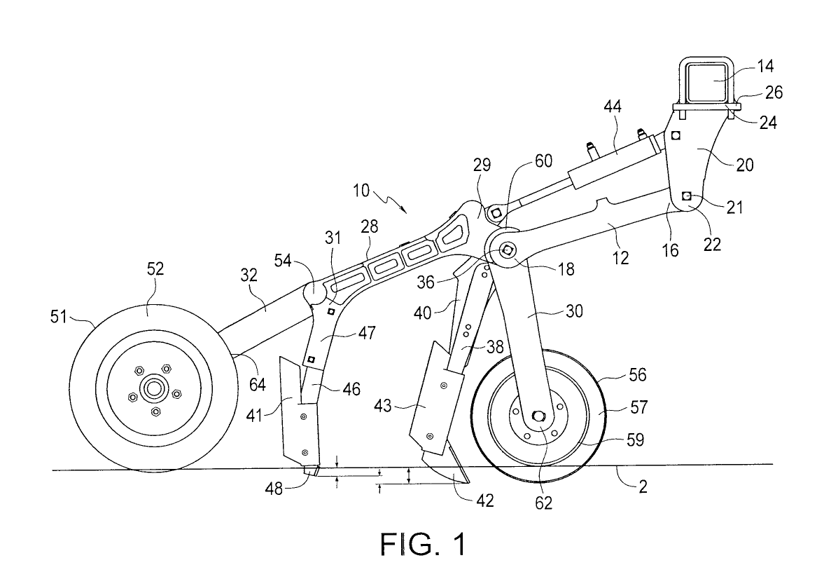

FIG. 1 is a schematic side view of an embodiment of a ground opener assembly 10 of the present invention. In this embodiment, the ground opener assembly 10 is a dual material dispensing ground opener assembly and is shown operating in flat field conditions with both ground openers positioned in the ground 2. Ground opener assembly 10 comprises a first member 12, which serves as the main link between the toolbar 14 of a seeding device and the remaining components of the ground opener assembly 10. In one example, toolbar 14 is set approximately 34″ from the ground 2. The first member 12 comprises a proximal end 16 and a distal end 18. Proximal end 16 of the first member 12 is pivotably attached to a first end 22 of a mounting device 20, which mounts the ground opener assembly 10 to the toolbar 14, by a pivot joint 21. Mounting device 20 further comprises a second end 24 to which a mounting bracket 26 is attached. Mounting bracket 26 is the means by which the ground opener assembly 10 attaches to the toolbar 14.

Ground opener assembly 10 further comprises a second member 28, having a proximal end 29 and a distal end 31. Attached to the proximal end 29 is a first arm 30 and attached to the distal end 31 is a second arm 32. The non-joined ends of the arms are spaced apart from one another and, in one embodiment, form an inverted V-shape. It is understood that second member 28, first arm 30 and second arm 32 may formed as a single unit or the first and second arms may be welded to second member 28. Either way, it is understood that second member 28, first arm 30 and second arm 32 function as a single unit. In one embodiment, first arm 30 and/or second arm 32 may be attached to the respective ends, 29, 31, of second member in such a fashion that the depth of these arms can be adjusted up or down. However, once the depth of the arms are set, the second member, first arm and second arm still operate as a single unit. Second member 28 is pivotably attached to the distal end 18 of first member 12 by pivot joint 36 so that second member 28, first arm 30 and second arm 32 will all pivot in unison.

Also pivotably attached at or near the proximal end 29 of second member 28 and, in this embodiment, also pivotably attached to the distal end 18 of first member 12, is a first opener 38 for dispensing a first material, such as fertilizer, to a first depth in the ground 2. In the embodiment shown in FIG. 1, first opener 38 is pivotably attached via trip plate 40 so that when the first opener 38 hits an obstacle or if the ground opener assemblies are being transported, the first opener 38 will trip, i.e., move backwards, so that the first opener 38 is not damaged. The proximal end 29 of second member 28 may be provided with a first stopping device (not shown) which prevents the trip plate 40 from over-rotating too far to the left (clockwise) or too far to the right (counter-clockwise). It is understood, however, that first opener 38 could be fixedly attached to either the proximal end 29 of the second member 28 or to the distal end 18 of first member 12, or both.

In the illustrated embodiment, the first opener 38 includes a knife 42 for forming a first furrow in the ground 2. Immediately behind knife 42, there is a tube holder 43 for receiving a tube for dispensing a first material, in this case fertilizer, into the first furrow from a supply source. It is understood that fertilizer can be either in particulate, liquid and/or gaseous form.

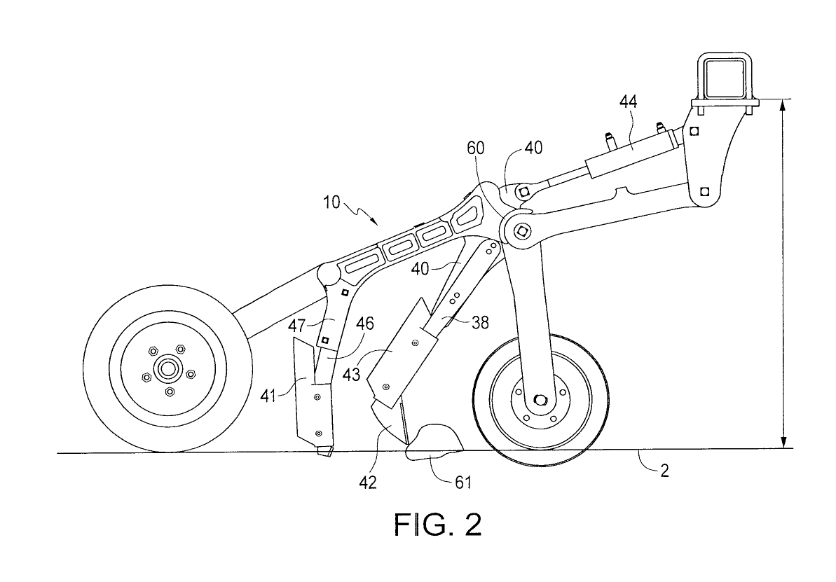

The tripping mechanism in operation can be seen in more detail in FIG. 2. The knife 42 of first opener 38 hits a rock 61 which causes the trip plate 40 of first opener 38 to rotate clockwise. The hydraulic cylinder 44 compresses and the first opener 38 is lifted thereby preventing the knife 42 from being damaged. In one embodiment, the hydraulic cylinder is a double acting hydraulic cylinder.

A second opener 46 for dispensing a second material, such as seed, to a second depth, preferably different from the first depth, is rigidly mounted near the proximal end 31 of second member 28. In the illustrated embodiment, the second opener 46 also includes a knife 48 positioned for forming a second furrow in the ground. Immediately behind knife 48, there generally is a second tube holder 41 for holding a tube for dispensing a second material, in this case seed, into the second furrow from a supply source. It is understood that the knife-holding portion 47 of the second opener 46 could also be formed as an integral part of second member 28. In any event, the second opener 46 acts in unity with second member 28.

A downwardly biasing device, illustrated in FIG. 1 as hydraulic cylinder 44, is attached at a first end to mounting device 20 and at a second end to trip plate 40. However, it is understood that the first end could be attached to the frame directly or by mounting means known in the art and the second end of the hydraulic cylinder could be attached to any rigid part of the ground opener assembly, for example, to second member 28. The hydraulic cylinder 44 operates to exert a downward bias force on second member 28 and thus a ground penetrating force to first opener 38 and second opener 46. Hydraulic cylinder 44 also exerts a compressing force to first arm 30 and second arm 32. Hydraulic cylinder 44 is also used to raise the ground opener assembly 10 for transport, which transport position will be described in more detail below. It is understood that other biasing devices such as springs, air bags or the like can also be used.

Attached to the free end 64 of second arm 32 of second member 28 is a packing/gauging device, rear gauging device 51, comprising a ground engaging or compressing member, illustrated herein in the form of a wheel element, rear packer wheel 52. In one embodiment, second arm 32 is attached to second member 28 by means of a pivot 54 so that the packer wheel 52 depth can be set using a packer wheel depth controller as is known in the art. However, it is understood that once the packer wheel 52 depth has been set, second arm 32 still acts as an integral member of second member 28.

In the alternative, depth control of packer wheel 52 can be controlled by attaching the packer wheel 52 to the free end 64 of second arm 32 using a vertical slotted plate so that the packer wheel 52 can be raised or lowered by moving it up or down within the slotted plate as needed, as is known in the art.

It will be appreciated, however, that a person skilled in the art would understand that alternative ground compressing members are also possible such as skids, pneumatic packers, semi-pneumatic packers, etc.

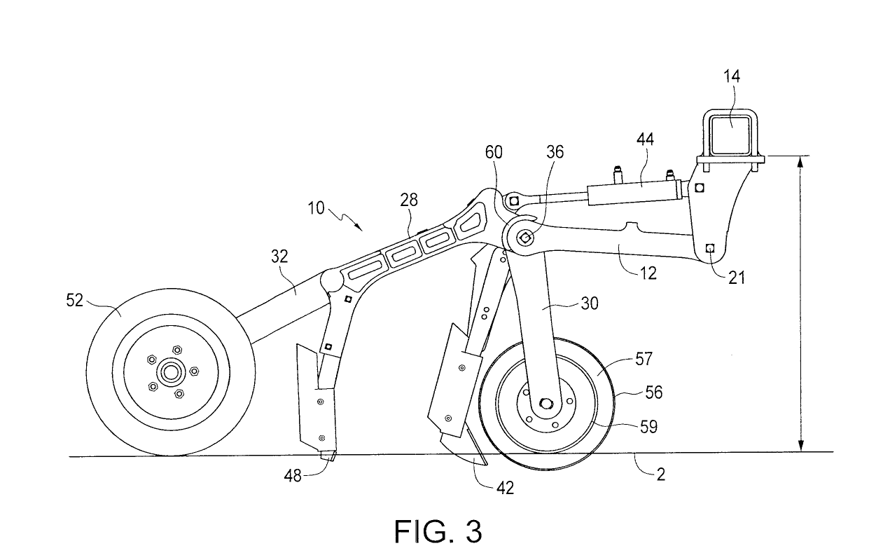

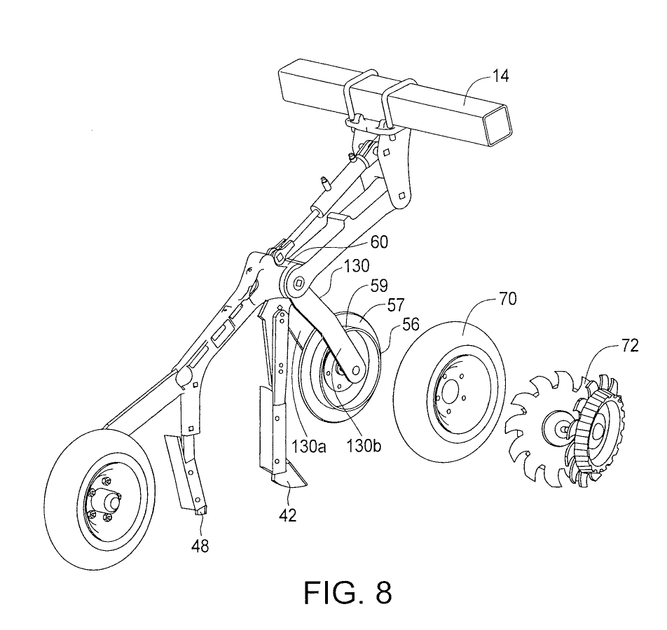

Ground opener assembly 10 further comprises a front gauging device 56 attached to the free end 62 of first arm 30. Thus, the depths of both knives (42, 48) of the ground opener assembly 10 are gauged by both the front gauging device 56 and the rear packer/gauge wheel 52. The cooperation of both the front gauging device 56 and the rear gauging device 51 can be seen more clearly in FIGS. 3-6. As illustrated in FIGS. 1-7, and which can be seen more clearly in the perspective view in FIG. 8, front gauging device 56 may be designed to perform a dual function. In this embodiment, front gauging device 56 may be comprised of blade 57, which aids in cutting through straw, stalks and the like, and a flat, ground following extended portion 59, which acts as the gauge.

Ground opener assembly 10 as illustrated in FIGS. 1-7 may further comprise a second stopping device for preventing the over-rotation of second member 28. In this embodiment, second stopping device is a cuff-like second stopping device 60 that prevents second member 28 (and, hence, front and rear gauging devices) from pivoting too far clockwise or too far counter-clockwise when the ground opener assembly 10 is travelling over sloped surfaces or when in transport position, as will be described in more detail below.

FIG. 3 depicts a situation where the ground opener assembly 10 encounters a 5″ rise in the ground 2. In this instance, the tool bar 14 will now be only 29″ from the ground 2. As can be seen in FIG. 3, ground opener assembly 10 of the present invention can easily compensate for the change in the ground level without changing the position of knives 42 and 48 in the ground 2. In particular, because first member 12 can freely pivot about pivot points 21 and 36, when hydraulic cylinder 44 compresses, first member 12 can pivot downwardly to compensate for the 5″ rise. As can be seen in FIG. 3, the fact that both front and rear gauging devices 56, 51, respectively, are attached to the second member 28, which member acts as a single piece, the knives 42 and 48 remain at the same position in the ground.

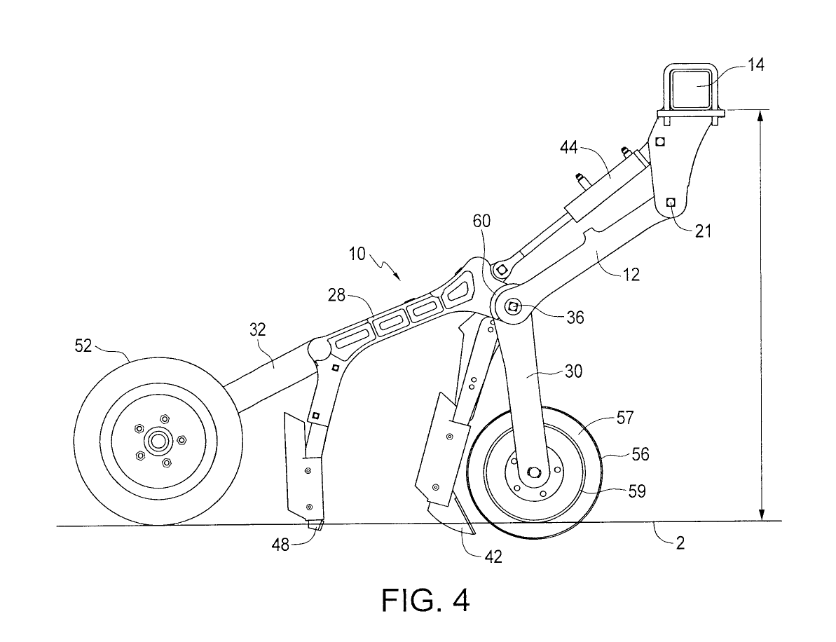

FIG. 4 depicts a situation where the ground opener assembly 10 encounters a 6″ gully in the ground 2. In this instance, the tool bar 14 will now be 40″ from the ground 2. In this instance, first member 12 can freely pivot about pivot points 21 and 36, when hydraulic cylinder 44 now expands, and thereby pivot upwardly to compensate for the 6″ drop. As can be seen in FIG. 4, the fact that both gauging devices 56, 51 are attached to the second member 28, which member acts as a single piece, the knives 42 and 48 remain at the same position in the ground.

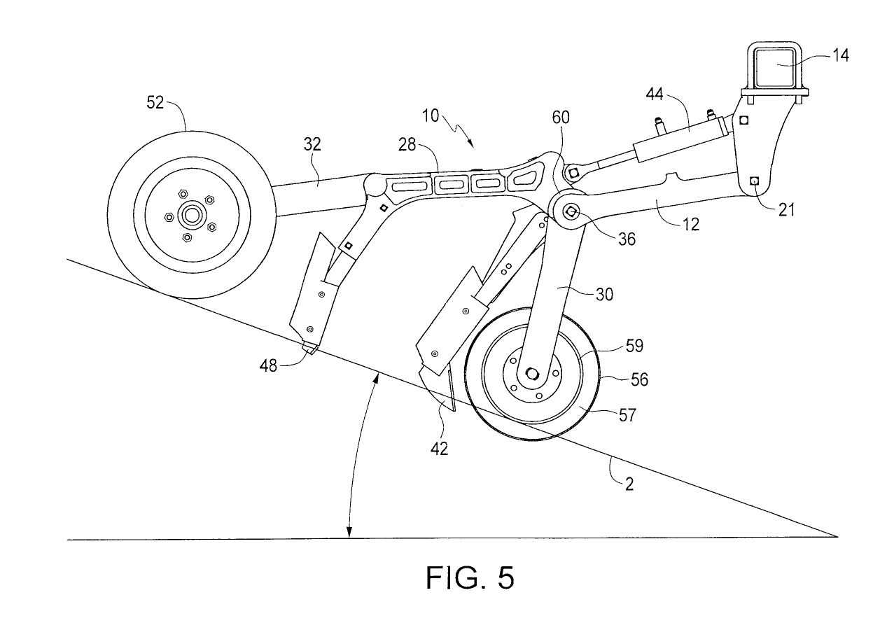

FIG. 5 depicts a situation where the ground opener assembly 10 encounters a 20° downward slope. In this instance, because second member 28 is pivotably attached to first member 12 by pivot 36 and because the front and rear gauging devices, 56 and 51, respectively, operate together, ground opener assembly 10 can compensate for the downward slope such that knives 42 and 48 remain at the same position in the ground and the same position relative to one another. Second stopping device 60 prevents second member 28 from pivoting too far in the clockwise direction and, therefore, lifting the two knives out of the soil.

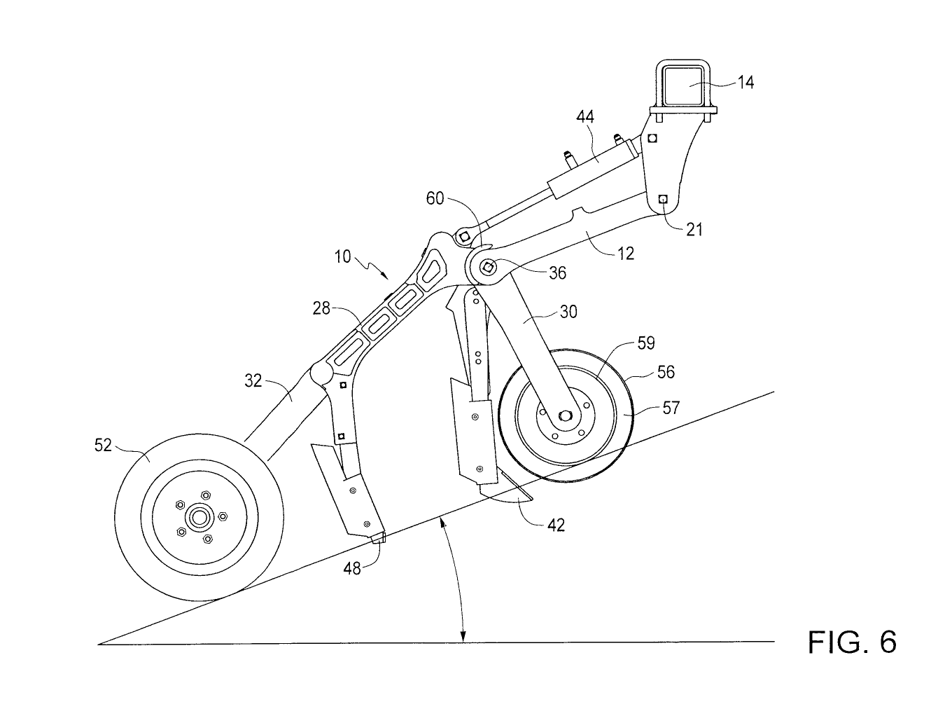

FIG. 6 depicts a situation where the opener assembly 10 encounters a 20° upward slope. In this instance, because second member 28 is pivotably attached to first member 12 by pivot 36 and because the front and rear gauging devices, 56, 51, operate together, ground opener assembly 10 can compensate for the upward slope such that knives 42 and 48 remain at the same position in the ground and the same position relative to one another. Second stopping device 60 prevents second member 28 from pivoting too far in the counterclockwise direction and potentially causing the front gauging device 56 to hit first member 12.

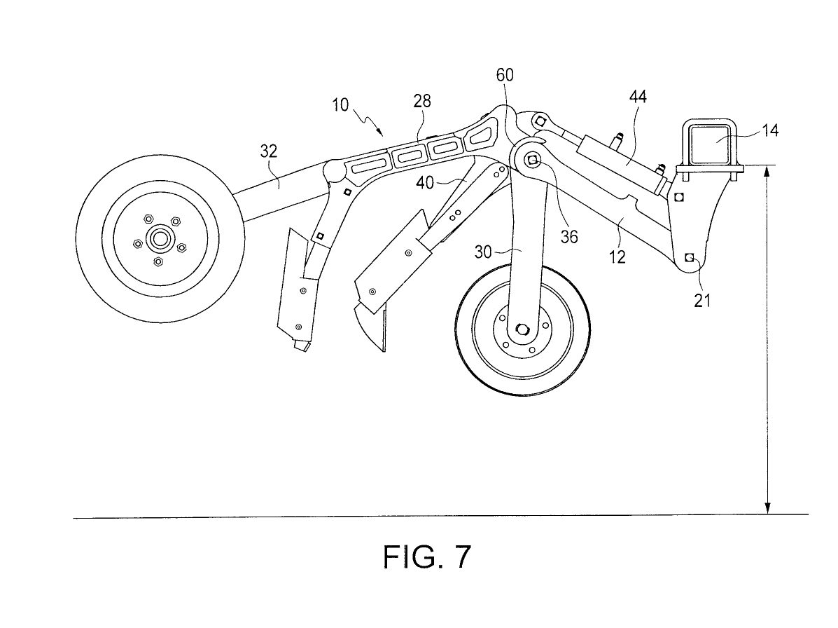

FIG. 7 shows the ground opener assembly 10 in the transport position. Trip plate 40 will be tripped back, i.e., rotated clockwise, to the transport position. Second member 28 will also rotate clockwise slightly until it hits second stopping device 60. Thus, in the transport potion, tool bar 14 will be about 34″ from the ground 2 and front gauge wheel will be lifted to about 13″ off the ground 2. In another aspect of the present invention, first arm 30 of second member 28 can be designed to accept a variety of different gauge devices on its free end which can perform additional functions besides acting as a front gauge for positioning the knives. FIG. 8 is a perspective view of an embodiment of the present invention which illustrates that first arm 130 may comprise two members or arms, member 130a and member 130b, for holding front gauging device 56, which, in this instance, comprises blade 57 and gauge portion 59. First arm 130 can also be used to hold a packer wheel 70, a double coulter disc gauging device 72, and the like. Packer wheel 70 is particularly useful in loose soil conditions, as it will function to both gauge and pack the soil down prior to application of product(s).

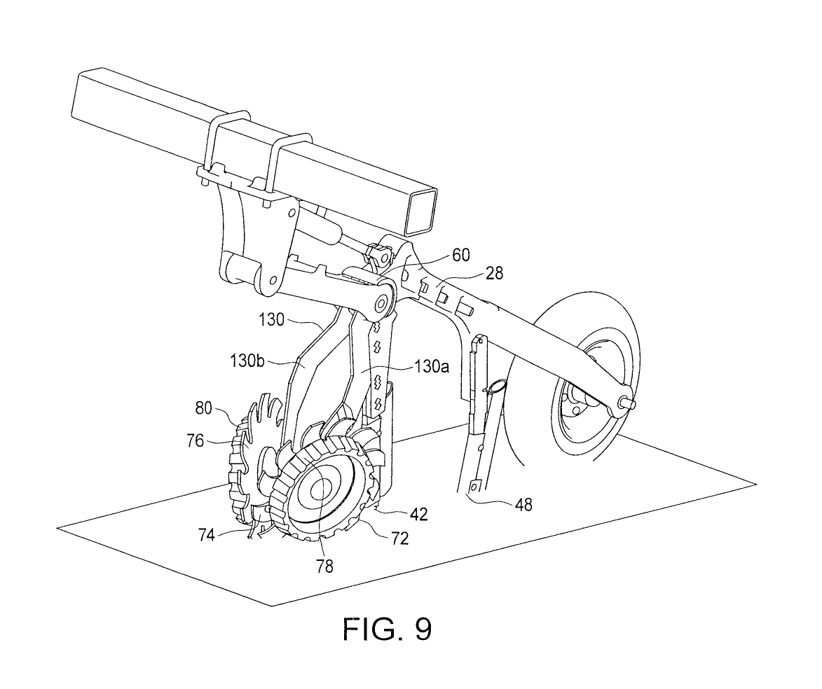

FIG. 9 shows an embodiment of the present invention where first arm 130 is holding a double coulter disc gauging device 72 between members 130a and 130b. Gauging device 72 comprises two coulter blades or discs, 74 and 76, and two gauging members 78 and 80. Thus, the coulter blades 74, 76 can act to cut through and/or push to the side, stubble, straw and the two gauging members 78, 80 act to gauge the two knives, 42 and 48, which are each shown in the ground.

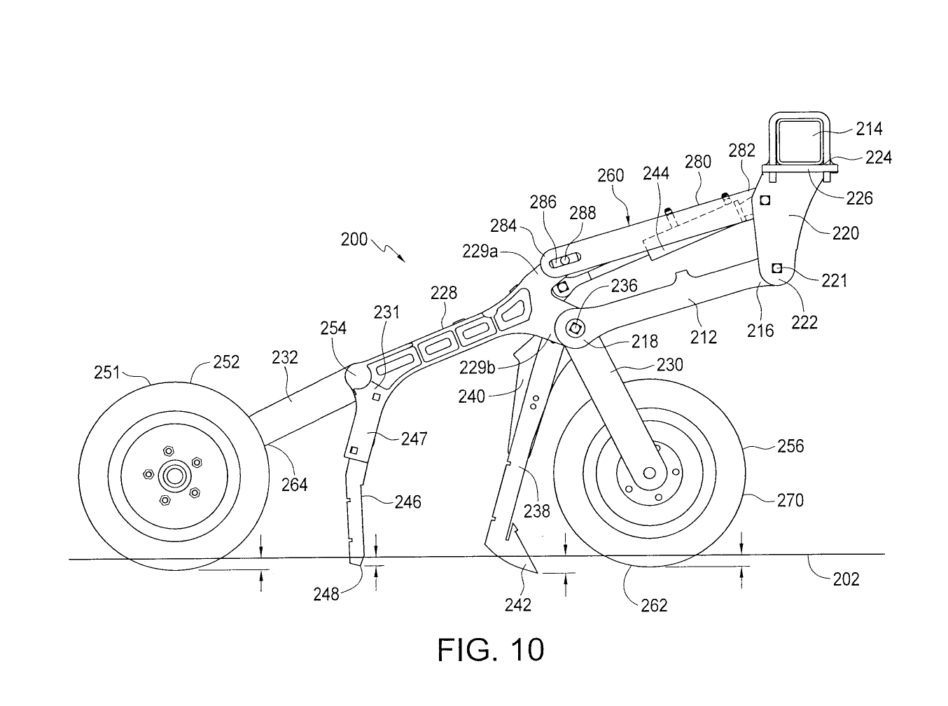

FIG. 10 is a schematic side view of another embodiment of a ground opener assembly 200 of the present invention. In this embodiment, the ground opener assembly 200 comprises a second stopping device 260 which not only prevents over-rotation of the assembly under certain working conditions but also stabilizes the ground opener assembly 200.

Once again, in this embodiment, the ground opener assembly 200 is a dual material dispensing ground opener assembly and is shown in FIG. 10 operating in flat field conditions with both first and second openers positioned in the ground 202. Ground opener assembly 200 comprises a first member 212, which serves as the main link between the toolbar 214 of a seeding device and the remaining components of the ground opener assembly 200. The first member 212 comprises a proximal end 216 and a distal end 218. Proximal end 216 of the first member 212 is pivotably attached to a first end 222 of a mounting device 220, which mounts the ground opener assembly 200 to the toolbar 214, by a pivot joint 221. Mounting device 220 further comprises a second end 224 to which a mounting bracket 226 is attached. Mounting bracket 226 is the means by which the ground opener assembly 200 attaches to the toolbar 214.

Ground opener assembly 200 further comprises a second member 228, having a first proximal end 229a, a second proximal end 229b, and a distal end 231. Attached to the second proximal end 229b is a first arm 230 and attached to the distal end 231 is a second arm 232. Once again, it is understood that second member 228, first arm 230 and second arm 232 may formed as a single unit or the first and second arms may be welded to second member 228 to form a single unit. Either way, it is understood that second member 228, first arm 230 and second arm 232 function as a single unit.

Also pivotably attached at or near the proximal end 229b of second member 228, and which may also be pivotably attached to the distal end 218 of first member 212, is a first opener 238 for dispensing a first material, such as fertilizer, to a first depth in the ground 202. First opener 238 may pivotably attached to proximal end 229b by means of a trip plate 240 so that when the first opener an obstacle or if the ground opener assemblies are being transported, the first opener will trip, i.e., move backwards, so that the first opener 238 is not damaged. The proximal end (229a/229b) of second member 228 may be provided with a first stopping device (not shown) which prevents the trip plate 240 from over-rotating too far to the left (clockwise) or too far to the right (counter-clockwise). It is understood, however, that first opener 238 could be fixedly attached to either the proximal end 229b of the second member 228 or to the distal end 218 of first member 212, or both. In the illustrated embodiment, the first opener 238 includes a knife 242 for forming a first furrow in the ground 202.

A second opener 246 for dispensing a second material, such as seed, to a second depth, preferably different from the first depth, is rigidly mounted near the proximal end 231 of second member 228. In the illustrated embodiment, the second opener 246 also includes a knife 248 positioned for forming a second furrow in the ground. It is understood that the knife-holding portion 247 of the second opener 246 could also be formed as an integral part of second member 228. In any event, the second opener 246 acts in unity with second member 228.

A downwardly biasing device, illustrated in FIG. 10 as hydraulic cylinder 244, is attached at a first end to mounting device 220 and at a second end to trip plate 240. However, it is understood that the first end of hydraulic cylinder 244 could be attached to the frame directly or by mounting means known in the art and the second end of the hydraulic cylinder 244 could be attached to any rigid part of the ground opener assembly, for example, to second member 228. The hydraulic cylinder 244 operates to exert a downward bias force on second member 228 and thus a ground penetrating force to first opener 238 and second opener 246. Hydraulic cylinder 244 also exerts a compressing force to first arm 230 and second arm 232. Hydraulic cylinder 244 is also used to raise the ground opener assembly 200 for transport, which transport position will be described in more detail below. It is understood that other biasing devices such as springs, air bags or the like can also be used.

Attached to the free end 264 of second arm 232 of second member 228 is a packing/gauging device, rear gauging device 251, comprising a ground engaging or compressing member, illustrated herein in the form of a wheel element, rear packer wheel 52. In one embodiment, second arm 232 is attached to second member 228 by means of a pivot 254 so that the packer wheel 252 depth can be set using a packer wheel depth controller as is known in the art. However, it is understood that once the packer wheel 252 depth has been set, second arm 232 still acts as an integral member of second member 228. Ground opener assembly 200 further comprises a front gauging device 256 attached to the free end 262 of first arm 230, shown in FIG. 10 to comprise packer wheel 270. Thus, the depths of both knives (242, 248) of the ground opener assembly 200 are gauged by both the front gauging device 256 and the rear gauging device 251.

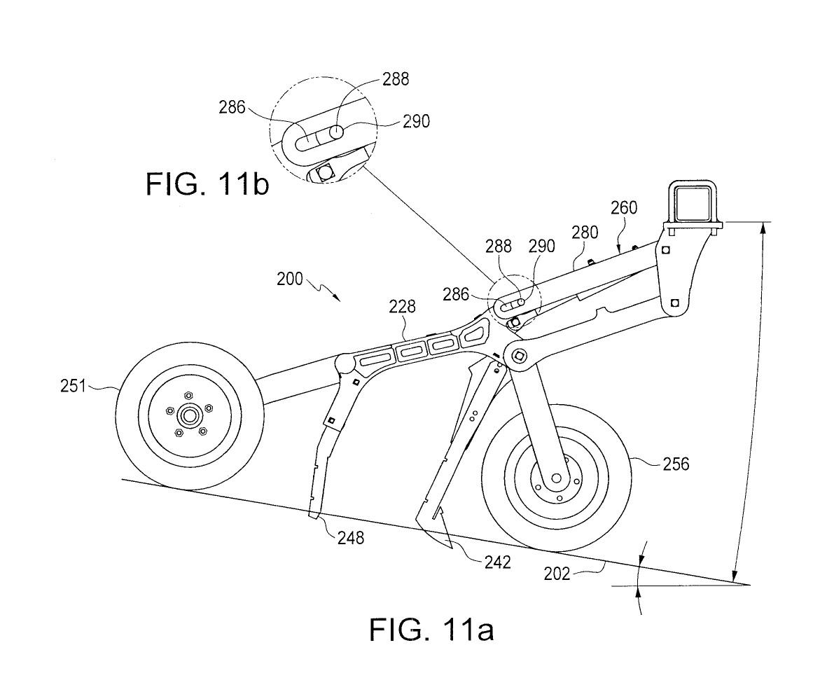

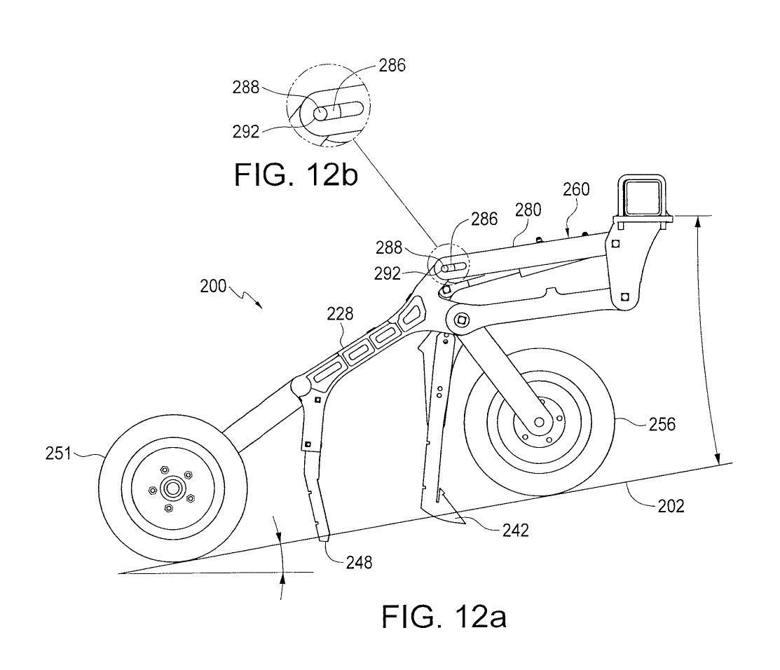

Ground opener assembly 200 further comprises a second stopping device 260 comprising a stopper arm 280 having a proximal end 282 and a distal end 284. Distal end 284 further comprises a slotted guide 286. Stopper arm 280 is attached to first proximal end 229a of second member 228 by means of bolt 288. The bolt 288 is positioned in the slotted guide 286 in such a fashion as to allow pivotable movement of second member 228 up and down relative to the stopper arm 280 but, in some circumstances, limit the pivotal movement of the second member 228 either clockwise or counterclockwise, as bolt 288 can also travel along the length of slotted guide 286, from the proximal end 290 to the distal end 292. The proximal end 282 of the stopper arm 280 is pivotably attached to the mounting device 220 at or near the second end 224 of mounting device 220, allowing the stopper arm to move up and down relative to the frame 214. Stopper arm 280 is particularly useful when seeding over hills (uphill and downhill) and will be described in more detail with reference to FIGS. 11 and 12.

FIGS. 11a and 11b illustrate a situation where the opener assembly 200 encounters a 20° downward slope (downhill). In this instance, because second member 228 is pivotably attached to first member 212 by pivot 236 and because the front and rear gauging devices, 256 and 251, respectively, operate together, ground opener assembly 200 can compensate for the downward slope such that knives 242 and 248 remain at the same position in the ground and the same position relative to one another. However, in order to prevent the ground opener assembly 200 from over-rotating clockwise and possibly lifting the knives 242 and 248 out of the ground 202, slotted guide 286 of stopper arm 280 allows second member 228 to only pivot so far to the left, until bolt 288 hits the proximal end 290 of slot 286, as shown in more detail in FIG. 11b.

Similarly, as shown in FIGS. 12a and 12b, when the opener assembly 200 encounters a 20° upward slope (uphill), because second member 228, front gauging device 256 and rear gauging device 251 operate as a single unit, ground opener assembly 200 can compensate for the upward slope such that knives 242 and 248 remain at the same position in the ground and the same position relative to one another. However, in order to prevent the ground opener assembly 200, in particular, second member 228, from over-rotating counter-clockwise, slotted guide 286 of stopper arm 280 allows second member 228 to only pivot so far to the right, until bolt 288 hits the distal end 292 of slot 286, as shown in more detail in FIG. 12b. This prevents front gauging device 256 from hitting first member 212.

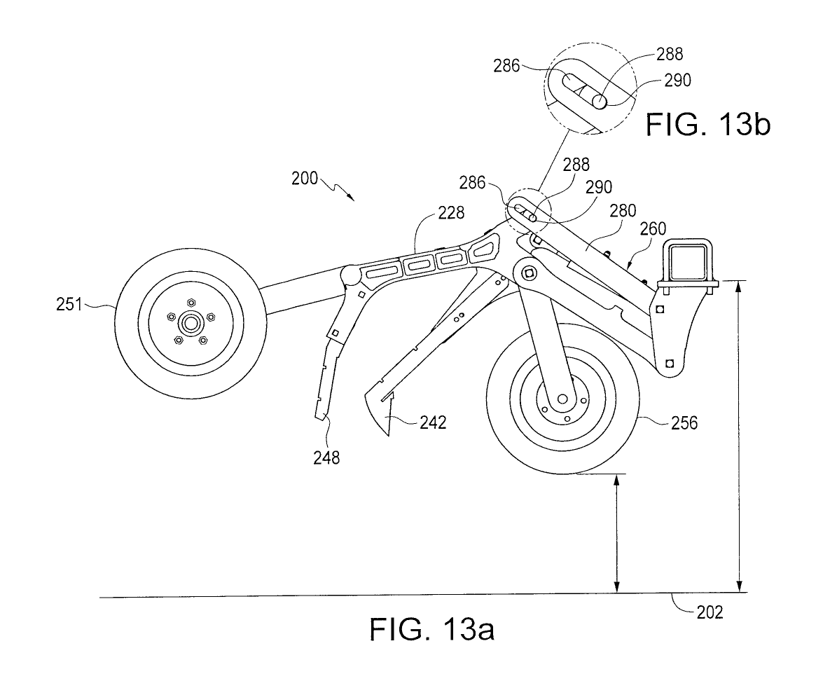

FIGS. 13a and 13b show the ground opener assembly 200 in the transport position. Trip plate 240 will be tripped back, i.e., rotated clockwise, to the transport position. Second member 228 will also rotate clockwise until bolt 288 hits the proximal end 290 of the slotted guide 286 of the stopper arm 280, seen in more detail in FIG. 13b. Thus, in the transport potion, tool bar 214 will be about 34″ from the ground 202 and front gauge device 256 will be lifted to about 13″ off the ground 202. FIG. 13c shows the ground opener assembly 200 in the transport position where stopper arm 280 has been removed. In this instance, over-rotation of second member 228 causes front gauging device 256 to dip closer to the ground, allowing for less clearance of the ground opener assembly, for example, only about 2-3 inches as compared to about 13 inches.

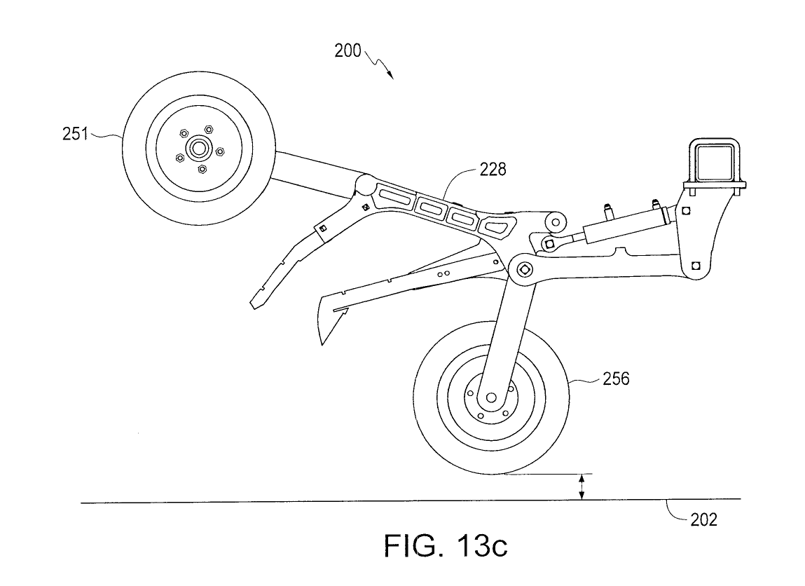

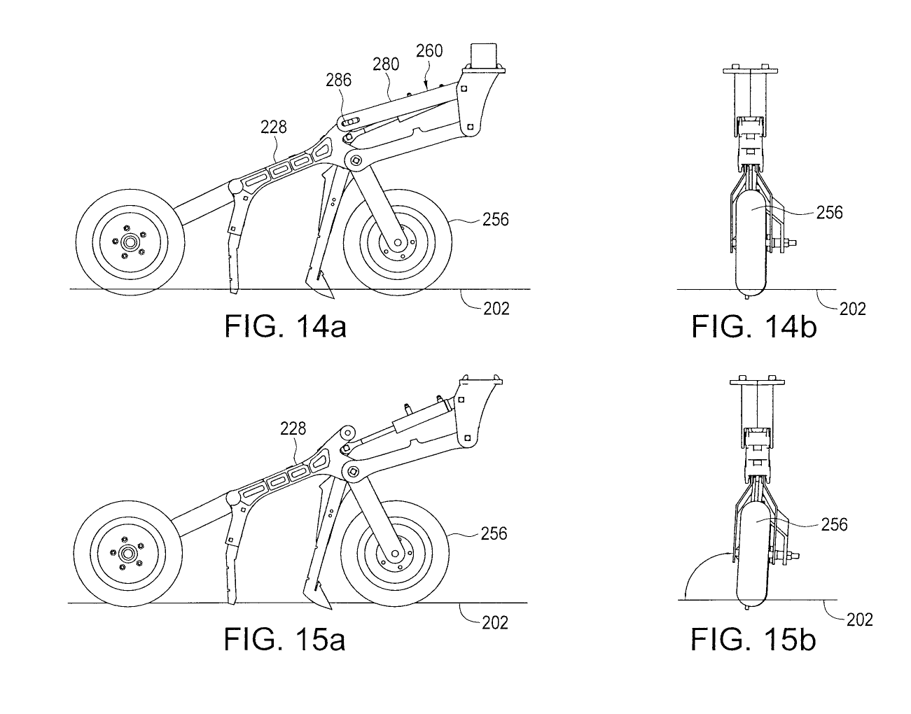

It was also surprisingly discovered that use of a second stopping device 260 comprising a stopper arm having a slotted guide provided the additional benefit of stabilizing ground opener assemblies. FIGS. 14a and 14b show a schematic and perspective view, respectively, of ground opener assembly 200 with stopper arm 280 having slotted guide 286. In particular, FIG. 14b is a rear perspective view of first gauging device 256. It was observed that stopper arm 280 helped in maintaining first gauging device 256 perpendicular to the ground 202. However, when stopper arm 280 was removed from ground opener assembly 200, as shown in FIG. 15a, it was observed that first gauging device 256 was tilted at an angle and was no longer perpendicular to the ground 202 (FIG. 15b).

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A ground opener assembly mountable to a tool bar of a seeder for depositing a at least one product into the ground, comprising:
a first member having a proximal end and a distal end, the proximal end of the first member pivotably attached to the tool bar;
a second member having a proximal end and a distal end, said proximal end being pivotably attached to the distal end of the first member;
a first arm having one end attached at or near the proximal end of the second member and a second arm having one end attached at or near the distal end of the second member, whereby the second member, first arm and second arm operate as a single unit;
a first opener attached at or near the proximal end of the second member for forming a furrow into the ground and depositing a first product therein;
a second opener attached at or near the distal end of the second member for forming a furrow into the ground and depositing a second product therein;
a front gauging device attached to the free end of the first arm and a back gauging device attached to the free end of the second arm; and
a biasing device operative to exert a downward bias force on the second member, the first and second openers, and the front and back gauging devices.

2. The ground opener assembly as claimed in claim 1 wherein the second member, first arm and second arm are formed as a single structural unit.

3. The ground opener assembly as claimed in claim 1 wherein the first opener and the second opener each comprises a knife for cutting the furrow into the ground.

4. The ground opener assembly as claimed in claim 1 wherein the first and second gauging devices each comprises a packer wheel.

5. The ground opener assembly as claimed in claim 1 wherein the first opener is adapted to deposit fertilizer in the furrow and the second opener is adapted to deposit seed in the furrow.

6. The ground opener assembly as claimed in claim 1 wherein the first gauging device comprises at least one cutting device for cutting through straw and the second gauging device comprises a packer wheel.

7. The ground opener assembly as claimed in claim 1 wherein the first member is pivotably attached to the tool bar by means of a mounting device having a first end to which the first member is pivotably attached and a second end which is mounted to the tool bar.

8. The ground opener assembly as claimed in claim 1 wherein the first opener is pivotably attached to the second member to allow the first opener to trip when encountering a rock.

9. The ground opener assembly as claimed in claim 1, further comprising a stopping device for preventing over-rotation of the second member.

10. The ground opener assembly as claimed in claim 9, wherein the stopping device comprises a stopper arm having a front end pivotably attached to the tool bar and a rear end pivotably attached to the second member by means of a slotted guide.

11. The ground opener assembly of claim 9, wherein the stopping device limits the clockwise pivotable movement of the second member when the ground opener assembly is travelling downhill.

12. The ground opener assembly of claim 9, wherein the stopping device limits the counter-clockwise pivotable movement of the second member when the ground opener assembly is travelling uphill.

13. The ground opener assembly of claim 9, wherein the stopping device limits the clockwise pivotable movement of the second member when the ground opener assembly is in a transport position.

14. The ground opener assembly of claim 10, wherein the slotted guide of the stopper arm operates to limit the clockwise pivotable movement of the second member when the ground opener assembly is travelling downhill.

15. The ground opener assembly of claim 10, wherein the slotted guide of the stopper arm operates to limit the counter-clockwise pivotable movement of the second member when the ground opener assembly is travelling uphill.

16. The ground opener assembly of claim 10, wherein the slotted guide of the stopper arm operates to limit the clockwise pivotable movement of the second member when the ground opener assembly is in a transport position.
